(19) United States
(12) Patent Application Publication
(10) Pub. No.: US 2025/0097679 A1
(43) Pub. Date: Mar. 20, 2025

(54) UU-BASED SIDELINK FEEDBACK

(71) Applicant: QUALCOMM Incorporated, San Diego, CA (US)

(72) Inventors: Anantharaman BALASUBRAMANIAN, San Diego, CA (US); Shuanshuan WU, San Diego, CA (US)

(21) Appl. No.: 18/469,242

(22) Filed: Sep. 18, 2023

(51) Int. Cl. H04W 4/40; H04L 5/00; H04W 92/18

(52) U.S. Cl. CPC H04W 4/40; H04L 5/0053; H04W 92/18

(57) ABSTRACT

Various aspects of the present disclosure generally relate to wireless communication. Some aspects relate to hybrid automatic repeat request (HARQ) feedback for sidelink communications. Some aspects more specifically relate to providing HARQ feedback for sidelink communications over a Uu interface. In some aspects, HARQ feedback is provided over a Uu interface for sidelink communications between vehicles. For example, the HARQ feedback may be provided via a vehicle-to-network-to-vehicle (V2N2V) interface in response to a connected groupcast or connectionless groupcast communication.

### FIELD OF THE DISCLOSURE

Aspects of the present disclosure generally relate to wireless communication and specifically, to techniques and apparatuses for sidelink feedback over a Uu interface.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In the context of 5G wireless communication, sidelink allows direct communication between a first user equipment (UE) and a second UE without the intervention of a traditional base station. Hybrid automatic repeat request (HARQ) feedback is an error control technique used in sidelink communications. Examples of HARQ feedback messages may include an acknowledgement (ACK), indicating that a sidelink message was received, or a negative ACK (NACK), indicating that a sidelink message needs to be retransmitted. Sidelink communication has a relatively limited range, however, and there are situations, such as vehicle-to-vehicle (V2V) communications, where the range for sidelink communication may be inadequate.

### SUMMARY

Some aspects described herein relate to a method of wireless communication performed by a transmitting user equipment (Tx UE). The method may include receiving a vehicle-to-network-to-everything (V2N2X) configuration for communication with one or more receiving UEs (Rx UEs). The method may include transmitting, via a Uu interface, a V2N2X message to a serving network node in accordance with the V2N2X configuration. The method may include receiving, via the Uu interface, feedback associated with the V2N2X message via the serving network node, the feedback being associated with one or more feedback messages output by the one or more Rx UEs.

Some aspects described herein relate to a method of wireless communication performed by an Rx UE. The method may include receiving, via a Uu interface, one or more V2N2X messages from a serving network node, the one or more V2N2X messages each being associated with a Tx UE. The method may include receiving one or more uplink feedback configurations from the serving network node. The method may include transmitting, via the Uu interface, one or more feedback messages, each associated with at least one of the one or more V2N2X messages, to the serving network node in accordance with the one or more uplink feedback configurations.

Some aspects described herein relate to a method of wireless communication performed by a transmitting network node. The method may include identifying one or more receiving network nodes, each associated with one or more Rx UEs. The method may include receiving, via a Uu interface, a V2N2X message transmitted by a Tx UE. The method may include transmitting the V2N2X message to the one or more receiving network nodes via an X2 interface. The method may include receiving one or more feedback messages from the one or more Rx UEs. The method may include transmitting feedback to the Tx UE via the Uu interface, the feedback being associated with the one or more feedback messages received from the one or more Rx UEs.

Some aspects described herein relate to a method of wireless communication performed by a receiving network node. The method may include receiving, via an X2 interface, a V2N2X message from a transmitting network node. The method may include transmitting, via a Uu interface, one or more uplink feedback configurations to one or more Rx UEs. The method may include receiving, via the Uu interface, one or more feedback messages, each associated with one of the one or more Rx UEs. The method may include transmitting each of the one or more feedback messages to the transmitting network node via the X2 interface.

Some aspects described herein relate to a Tx UE for wireless communication. The Tx UE may include one or more memories storing processor readable code and one or more processors coupled with the one or more memories. The one or more processors may be individually or collectively operable to cause the Tx UE to receive a V2N2X configuration for communication with one or more Rx UEs. The one or more processors may be individually or collectively operable to cause the Tx UE to transmit, via a Uu interface, a V2N2X message to a serving network node in accordance with the V2N2X configuration. The one or more processors may be individually or collectively operable to cause the Tx UE to receive, via the Uu interface, feedback associated with the V2N2X message via the serving network node, the feedback being associated with one or more feedback messages output by the one or more Rx UEs.

Some aspects described herein relate to an Rx UE for wireless communication. The Rx UE may include one or more memories storing processor readable code and one or more processors coupled with the one or more memories. The one or more processors may be individually or collectively operable to cause the Rx UE to receive, via a Uu interface, one or more V2N2X messages from a serving network node, the one or more V2N2X messages each being associated with a Tx UE. The one or more processors may be individually or collectively operable to cause the Rx UE to receive one or more uplink feedback configurations from the serving network node. The one or more processors may be individually or collectively operable to cause the Rx UE to transmit, via the Uu interface, one or more feedback messages, each associated with at least one of the one or more V2N2X messages, to the serving network node in accordance with the one or more uplink feedback configurations.

Some aspects described herein relate to a transmitting network node for wireless communication. The transmitting network node may include one or more memories storing processor readable code and one or more processors coupled with the one or more memories. The one or more processors may be individually or collectively operable to cause the transmitting network node to identify one or more receiving network nodes, each associated with one or more Rx UEs. The one or more processors may be individually or collectively operable to cause the transmitting network node to receive, via a Uu interface, a V2N2X message transmitted by a Tx UE. The one or more processors may be individually or collectively operable to cause the transmitting network node to transmit the V2N2X message to the one or more receiving network nodes via an X2 interface. The one or more processors may be individually or collectively operable to cause the transmitting network node to receive one or more feedback messages from the one or more Rx UEs. The one or more processors may be individually or collectively operable to cause the transmitting network node to transmit feedback to the Tx UE via the Uu interface, the feedback being associated with the one or more feedback messages received from the one or more Rx UEs.

Some aspects described herein relate to a receiving network node for wireless communication. The receiving network node may include one or more memories storing processor readable code and one or more processors coupled with the one or more memories. The one or more processors may be individually or collectively operable to cause the receiving network node to receive, via an X2 interface, a V2N2X message from a transmitting network node. The one or more processors may be individually or collectively operable to cause the receiving network node to transmit, via a Uu interface, one or more uplink feedback configurations to one or more Rx UEs. The one or more processors may be individually or collectively operable to cause the receiving network node to receive, via the Uu interface, one or more feedback messages, each associated with one of the one or more Rx UEs. The one or more processors may be individually or collectively operable to cause the receiving network node to transmit each of the one or more feedback messages to the transmitting network node via the X2 interface.

Some aspects described herein relate to a non-transitory computer-readable medium that stores a set of instructions for wireless communication by a Tx UE. The set of instructions, when executed by one or more processors of the Tx UE, may cause the Tx UE to receive a V2N2X configuration for communication with one or more Rx UEs. The set of instructions, when executed by one or more processors of the Tx UE, may cause the Tx UE to transmit, via a Uu interface, a V2N2X message to a serving network node in accordance with the V2N2X configuration. The set of instructions, when executed by one or more processors of the Tx UE, may cause the Tx UE to receive, via the Uu interface, feedback associated with the V2N2X message via the serving network node, the feedback being associated with one or more feedback messages output by the one or more Rx UEs.

Some aspects described herein relate to a non-transitory computer-readable medium that stores a set of instructions for wireless communication by an Rx UE. The set of instructions, when executed by one or more processors of the Rx UE, may cause the Rx UE to receive, via a Uu interface, one or more V2N2X messages from a serving network node, the one or more V2N2X messages each being associated with a Tx UE. The set of instructions, when executed by one or more processors of the Rx UE, may cause the Rx UE to receive one or more uplink feedback configurations from the serving network node. The set of instructions, when executed by one or more processors of the Rx UE, may cause the Rx UE to transmit, via the Uu interface, one or more feedback messages, each associated with at least one of the one or more V2N2X messages, to the serving network node in accordance with the one or more uplink feedback configurations.

Some aspects described herein relate to a non-transitory computer-readable medium that stores a set of instructions for wireless communication by a transmitting network node. The set of instructions, when executed by one or more processors of the transmitting network node, may cause the transmitting network node to identify one or more receiving network nodes, each associated with one or more Rx UEs. The set of instructions, when executed by one or more processors of the transmitting network node, may cause the transmitting network node to receive, via a Uu interface, a V2N2X message transmitted by a Tx UE. The set of instructions, when executed by one or more processors of the transmitting network node, may cause the transmitting network node to transmit the V2N2X message to the one or more receiving network nodes via an X2 interface. The set of instructions, when executed by one or more processors of the transmitting network node, may cause the transmitting network node to receive one or more feedback messages from the one or more Rx UEs. The set of instructions, when executed by one or more processors of the transmitting network node, may cause the transmitting network node to transmit feedback to the Tx UE via the Uu interface, the feedback being associated with the one or more feedback messages received from the one or more Rx UEs.

Some aspects described herein relate to a non-transitory computer-readable medium that stores a set of instructions for wireless communication by a receiving network node. The set of instructions, when executed by one or more processors of the receiving network node, may cause the receiving network node to receive, via an X2 interface, a V2N2X message from a transmitting network node. The set of instructions, when executed by one or more processors of the receiving network node, may cause the receiving network node to transmit, via a Uu interface, one or more uplink feedback configurations to one or more Rx UEs. The set of instructions, when executed by one or more processors of the receiving network node, may cause the receiving network node to receive, via the Uu interface, one or more feedback messages, each associated with one of the one or more Rx UEs. The set of instructions, when executed by one or more processors of the receiving network node, may cause the receiving network node to transmit each of the one or more feedback messages to the transmitting network node via the X2 interface.

Some aspects described herein relate to an apparatus for wireless communication. The apparatus may include means for receiving a V2N2X configuration for communication with one or more Rx UEs. The apparatus may include means for transmitting, via a Uu interface, a V2N2X message to a serving network node in accordance with the V2N2X configuration. The apparatus may include means for receiving, via the Uu interface, feedback associated with the V2N2X message via the serving network node, the feedback being associated with one or more feedback messages output by the one or more Rx UEs.

Some aspects described herein relate to an apparatus for wireless communication. The apparatus may include means for receiving, via a Uu interface, one or more V2N2X messages from a serving network node, the one or more V2N2X messages each being associated with a Tx UE. The apparatus may include means for receiving one or more uplink feedback configurations from the serving network node. The apparatus may include means for transmitting, via the Uu interface, one or more feedback messages, each associated with at least one of the one or more V2N2X messages, to the serving network node in accordance with the one or more uplink feedback configurations.

Some aspects described herein relate to an apparatus for wireless communication. The apparatus may include means for identifying one or more receiving network nodes, each associated with one or more Rx UEs. The apparatus may include means for receiving, via a Uu interface, a V2N2X message transmitted by a Tx UE. The apparatus may include means for transmitting the V2N2X message to the one or more receiving network nodes via an X2 interface. The apparatus may include means for receiving one or more feedback messages from the one or more Rx UEs. The apparatus may include means for transmitting feedback to the Tx UE via the Uu interface, the feedback being associated with the one or more feedback messages received from the one or more Rx UEs.

Some aspects described herein relate to an apparatus for wireless communication. The apparatus may include means for receiving, via an X2 interface, a V2N2X message from a transmitting network node. The apparatus may include means for transmitting, via a Uu interface, one or more uplink feedback configurations to one or more Rx UEs. The apparatus may include means for receiving, via the Uu interface, one or more feedback messages, each associated with one of the one or more Rx UEs. The apparatus may include means for transmitting each of the one or more feedback messages to the transmitting network node via the X2 interface.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 4 is a diagram illustrating an example of connected groupcast feedback via vehicle-to-network-to-vehicle (V2N2V) communication.

FIG. 5 is a diagram illustrating an example of connectionless groupcast feedback via V2N2V communication.

FIG. 6 is a diagram illustrating an example associated with connectionless groupcast sidelink feedback over a Uu interface.

FIG. 7 is a diagram illustrating an example associated with one-to-many connectionless groupcast sidelink feedback over a Uu interface.

FIG. 8 is a flowchart illustrating an example process performed, for example, by a transmitting UE that supports Uu-based sidelink feedback.

FIG. 9 is a flowchart illustrating an example process performed, for example, by a receiving UE that supports Uu-based sidelink feedback.

FIG. 10 is a flowchart illustrating an example process performed, for example, by a transmitting network node that supports Uu-based sidelink feedback.

FIG. 11 is a flowchart illustrating an example process performed, for example, by a receiving network node that supports Uu-based sidelink feedback.

FIG. 12 is a diagram of an example apparatus (for example, a transmitting UE) for wireless communication that supports Uu-based sidelink feedback.

FIG. 13 is a diagram of an example apparatus (for example, a receiving UE) for wireless communication that supports Uu-based sidelink feedback.

FIG. 14 is a diagram of an example apparatus (for example, a transmitting network node) for wireless communication that supports Uu-based sidelink feedback.

FIG. 15 is a diagram of an example apparatus (for example, a receiving network node) for wireless communication that supports Uu-based sidelink feedback.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In the context of 5G wireless communication, sidelink allows direct communication between a first user equipment (UE) and a second UE without the intervention of a traditional base station. Hybrid automatic repeat request (HARQ) feedback is an error control technique used in sidelink communications. Examples of HARQ feedback messages may include an acknowledgement (ACK), indicating a sidelink message was received, or a negative ACK (NACK), indicating that a sidelink message needs to be retransmitted. Sidelink communication has a relatively limited range, however, and there are situations, such as vehicle-to-vehicle (V2V) or vehicle-to-everything (V2X) communications, where the range for sidelink communication may be inadequate.

Various aspects relate generally to hybrid automatic repeat request (HARQ) feedback for sidelink communications. Some aspects more specifically relate to providing hybrid automatic repeat request (HARQ) feedback for sidelink communications over a Uu interface. In some aspects, HARQ feedback is provided over a Uu interface for sidelink communications between vehicles. For example, the HARQ feedback may be provided via a vehicle-to-network-to-vehicle (V2N2V) or vehicle-to-network-to-everything (V2N2X) interface in response to a connected groupcast or connectionless groupcast communication.

In some aspects, a first network node serving a transmitting (Tx) UE may collect feedback from a second network node serving a first receiving (Rx) UE. In some aspects, the Tx UE may transmit distance and/or zone-based V2X messages, and the first network node may transmit the V2X messages to the second network node via an X2 interface. In some aspects, the second network node provides a grant for the first Rx UE to transmit uplink feedback associated with the V2X message.

In some aspects, the first network node may operate in accordance with the V2X message received from the Tx UE via the Uu interface. In some aspects, such as when the V2X message indicates one-to-many feedback, the first network node may transmit, to the second network node serving the first Rx UE and to a third network node serving a second Rx UE, an indication for one-to-many feedback in response to the V2X message. In some aspects, the first network node may receive feedback on the V2X message from the second network node and from the third network node. In some aspects, the second network node and the third network node transmit feedback received from the first Rx UE and the second Rx UE, respectively.

In some aspects, such as when one or more Rx UEs participate in multiple connected groupcast communications, the network nodes serving the one or more Rx UEs may provide uplink grant requests for providing feedback associated with the V2X message. In some aspects, the uplink grant may be provided separately for each connected groupcast of which an Rx UE participates. In some aspects, the uplink grant may be provided to Rx UEs in a multiplex manner, such as according to a slot number.

Particular aspects of the subject matter described in this disclosure can be implemented to realize one or more of the following potential advantages. In some examples, the described techniques can be used to improve sidelink performance by leveraging Uu network capabilities. In some examples, by providing sidelink feedback through their respective network nodes, the described techniques may allow an Rx UE to provide feedback on a connectionless groupcast sidelink communication despite operating in a non-connected mode. In some examples, by having the network nodes servicing the Rx UEs provide the respective Rx UEs with uplink grants for feedback on the V2X transmissions, the feedback can be transmitted to the network node more quickly than, for example, if the Rx UE had to transmit feedback on a random access channel. Moreover, the failure to receive the feedback during the slot indicated in the uplink grant may indicate that the Rx UE did not receive the V2X message, which may in turn trigger a retransmission of the V2X message, thereby increasing the likelihood that groupcast messages are received by the Rx UE. In some examples, by providing the uplink grant according to a slot number, the described techniques may allow the Rx UE to participate in multiple connected groupcast communications.

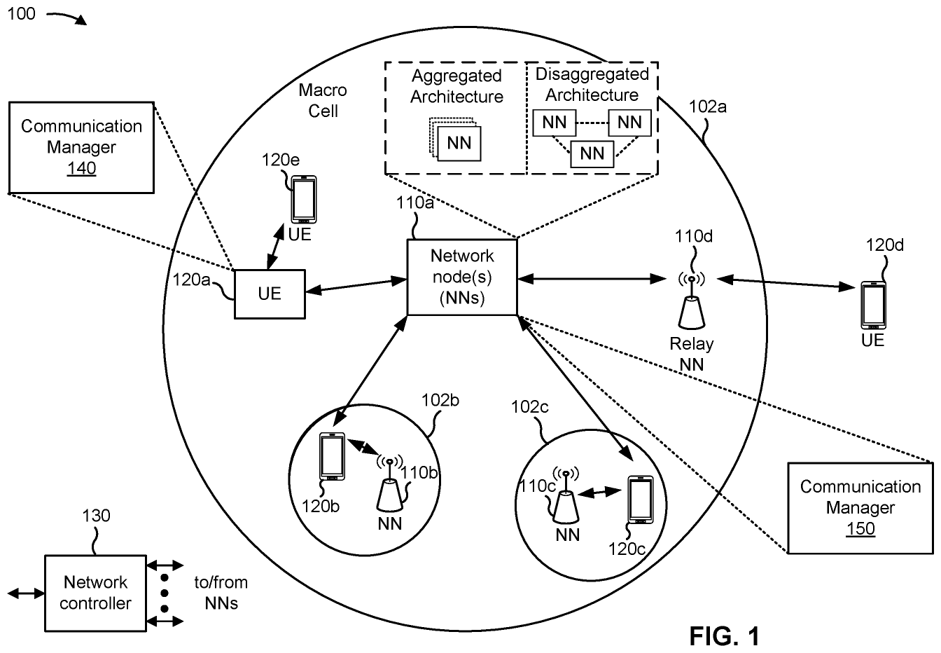

FIG. 1 is a diagram illustrating an example of a wireless network. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120c), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses (for example, an augmented reality (AR), virtual reality (VR), mixed reality, or extended reality (XR) headset), a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium. Some UEs 120 (for example, UEs 102a and 120e) may communicate directly using one or more sidelink channels (for example, without a network node as an intermediary to communicate with one another).

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol using for example a PC5 interface for direct communication, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110. In other examples, the two or more UEs 120 may communicate through a vehicle-to-network-vehicle (V2N2V) protocol for example by communicating through a Uu interface using the LTE and/or NR uplink and downlink.

In some aspects, the UE 120 may include a communication manager 140. As described in more detail elsewhere herein, the communication manager 140 may receive a V2N2X configuration for communication with one or more Rx UEs; transmit, via a Uu interface, a V2N2X message to a serving network node in accordance with the V2N2X configuration; and receive, via the Uu interface, feedback associated with the V2N2X message via the serving network node, the feedback being associated with one or more feedback messages output by the one or more Rx UEs. In some aspects, as described in more detail elsewhere herein, the communication manager 140 may receive, via a Uu interface, one or more V2N2X messages from a serving network node, the one or more V2N2X messages each being associated with a Tx UE; receive one or more uplink feedback configurations from the serving network node; and transmit, via the Uu interface, one or more feedback messages, each associated with at least one of the one or more V2N2X messages, to the serving network node in accordance with the one or more uplink feedback configurations. Additionally, or alternatively, the communication manager 140 may perform one or more other operations described herein.

In some aspects, the network node 110 may include a communication manager 150. As described in more detail elsewhere herein, the communication manager 150 may identify one or more receiving network nodes, each associated with one or more Rx UEs; receive, via a Uu interface, a V2N2X message transmitted by a Tx UE; transmit the V2N2X message to the one or more receiving network nodes via an X2 interface; receive one or more feedback messages from the one or more Rx UEs; and transmit feedback to the Tx UE via the Uu interface, the feedback being associated with the one or more feedback messages received from the one or more Rx UEs. In some aspects, as described in more detail elsewhere herein, the communication manager 150 may receive, via an X2 interface, a V2N2X message from a transmitting network node; transmit, via a Uu interface, one or more uplink feedback configurations to one or more Rx UEs; receive, via the Uu interface, one or more feedback messages, each associated with one of the one or more Rx UEs; and transmit each of the one or more feedback messages to the transmitting network node via the X2 interface. Additionally, or alternatively, the communication manager 150 may perform one or more other operations described herein.

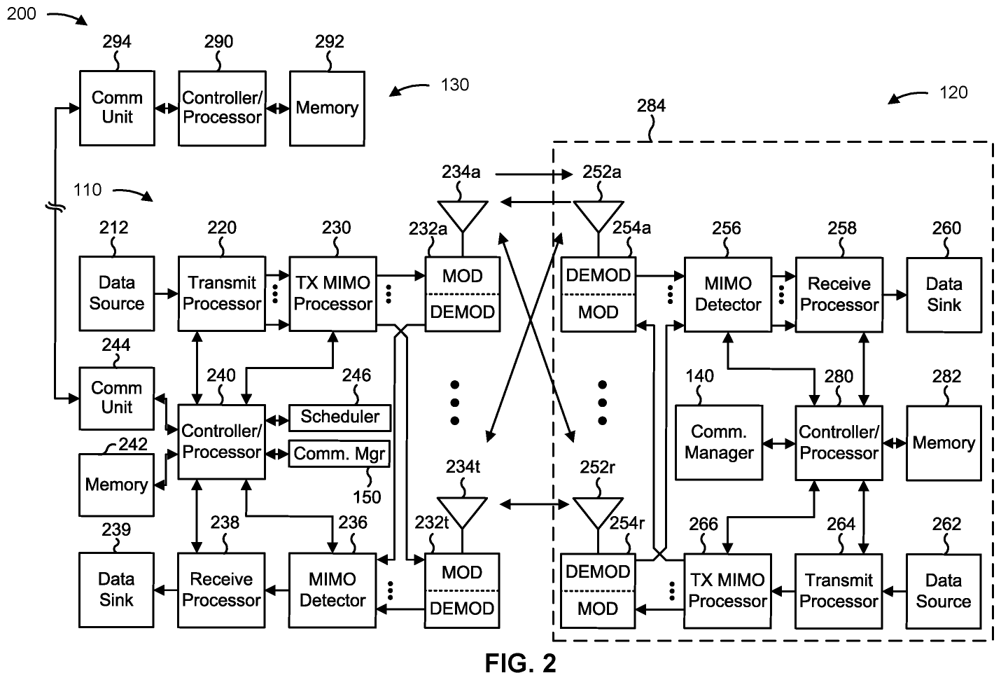

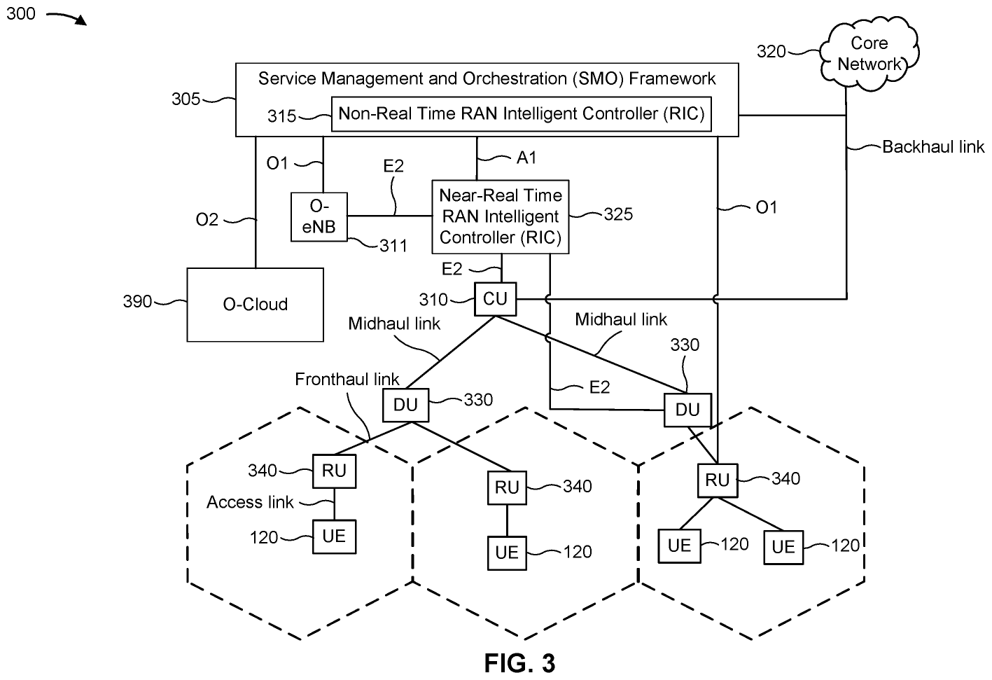

FIG. 2 is a diagram 200 illustrating an example network node in communication with a UE in a wireless network. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP. RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

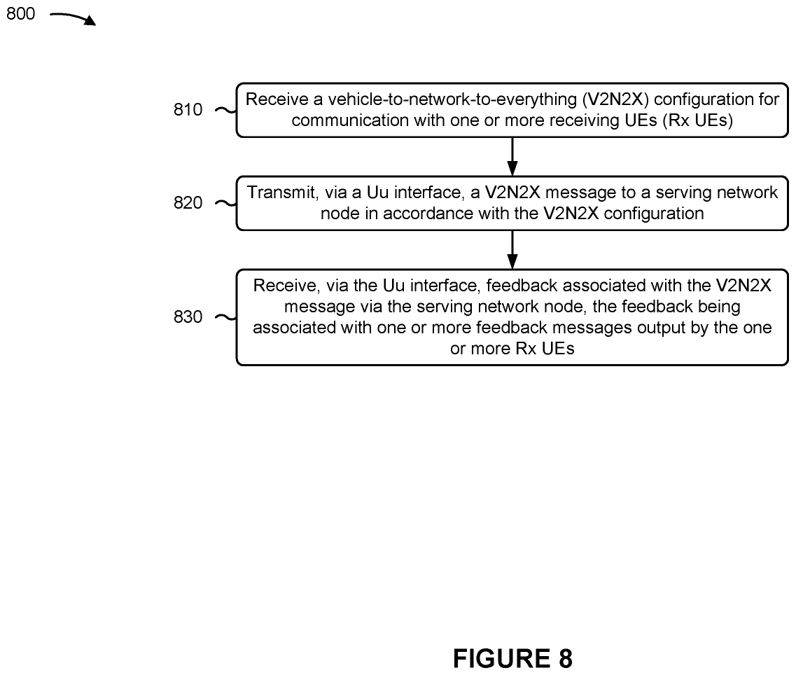

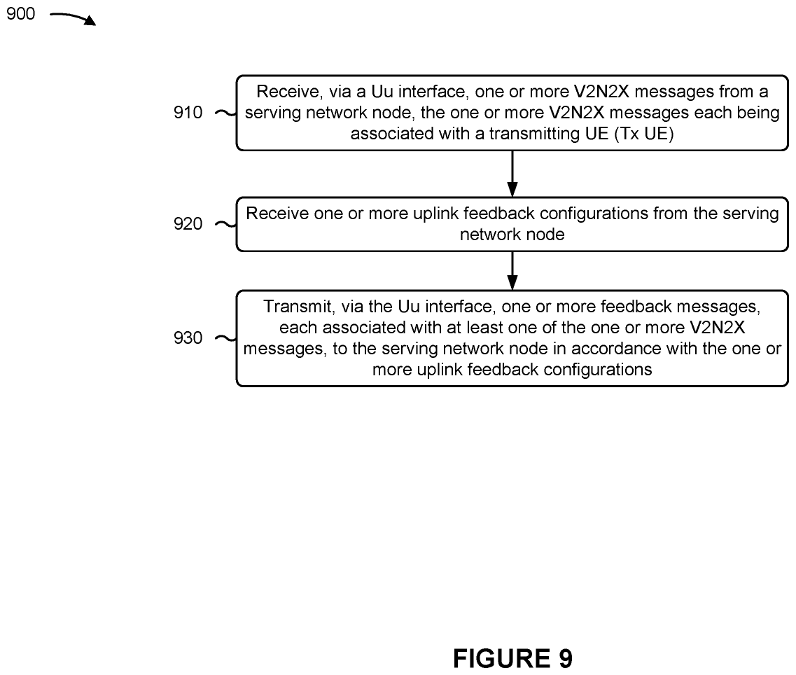

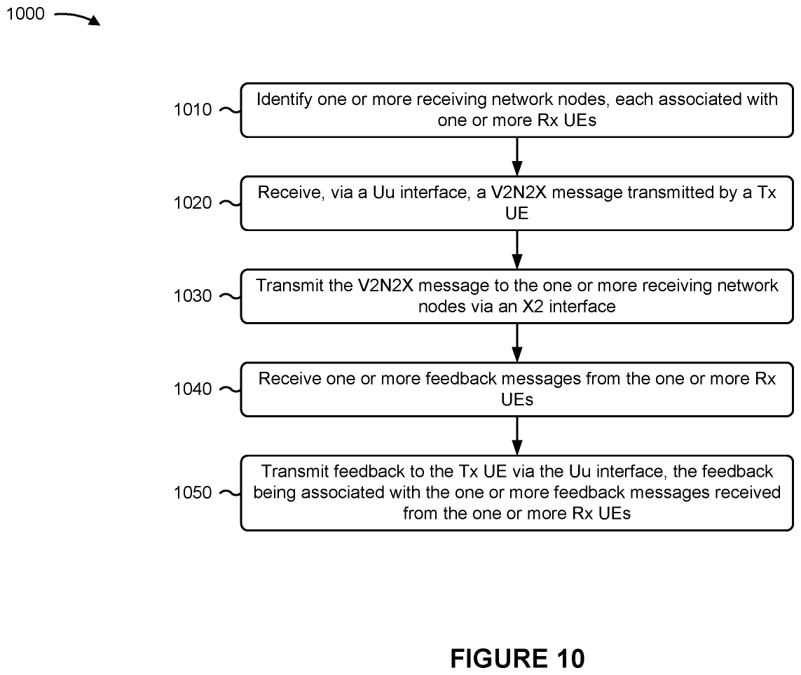

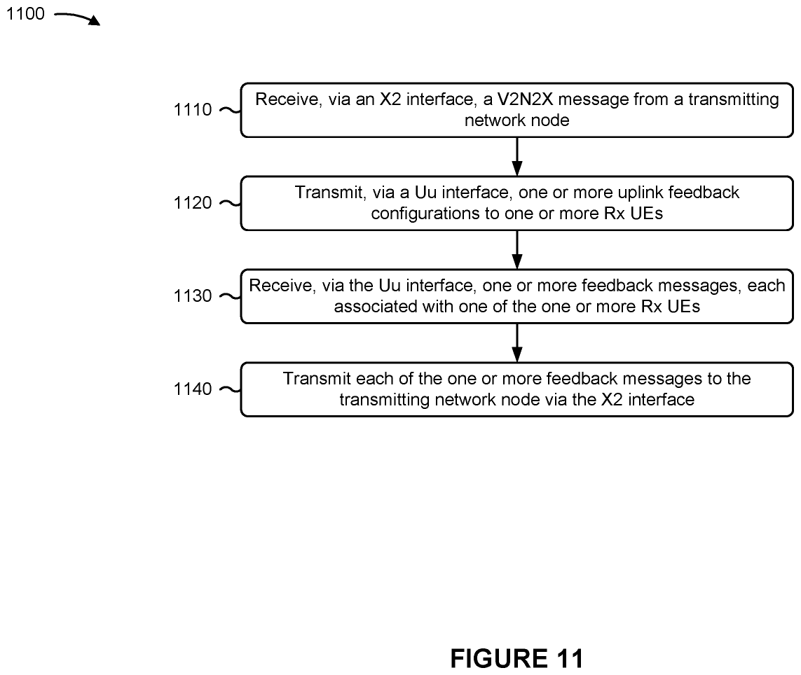

The controller/processor 240 of the network node 110, the controller/processor 280 of the UE 120, or any other component(s) of FIG. 2 may perform one or more techniques associated with Uu-based sidelink feedback, as described in more detail elsewhere herein. For example, the controller/processor 240 of the network node 110, the controller/processor 280 of the UE 120, or any other component(s) of FIG. 2 may perform or direct operations of, for example, process 800 of FIG. 8, process 900 of FIG. 9, process 1000 of FIG. 10, process 1100 of FIG. 11, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, a Tx UE (e.g., UE 120) includes means for receiving a V2N2X configuration for communication with one or more Rx UEs; means for transmitting, via a Uu interface, a V2N2X message to a serving network node in accordance with the V2N2X configuration; and/or means for receiving, via the Uu interface, feedback associated with the V2N2X message via the serving network node, the feedback being associated with one or more feedback messages output by the one or more Rx UEs. The means for the Tx UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an Rx UE (e.g., UE 120) includes means for receiving, via a Uu interface, one or more V2N2X messages from a serving network node, the one or more V2N2X messages each being associated with a Tx UE; means for receiving one or more uplink feedback configurations from the serving network node; and/or means for transmitting, via the Uu interface, one or more feedback messages, each associated with at least one of the one or more V2N2X messages, to the serving network node in accordance with the one or more uplink feedback configurations. The means for the Rx UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a Tx network node includes means for identifying one or more receiving network nodes, each associated with one or more Rx UEs; means for receiving, via a Uu interface, a V2N2X message transmitted by a Tx UE; means for transmitting the V2N2X message to the one or more receiving network nodes via an X2 interface; means for receiving one or more feedback messages from the one or more Rx UEs; and/or means for transmitting feedback to the Tx UE via the Uu interface, the feedback being associated with the one or more feedback messages received from the one or more Rx UEs. The means for the Tx network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an Rx network node includes means for receiving, via an X2 interface, a V2N2X message from a transmitting network node; means for transmitting, via a Uu interface, one or more uplink feedback configurations to one or more Rx UEs; means for receiving, via the Uu interface, one or more feedback messages, each associated with one of the one or more Rx UEs; and/or means for transmitting each of the one or more feedback messages to the transmitting network node via the X2 interface. The means for the Rx network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

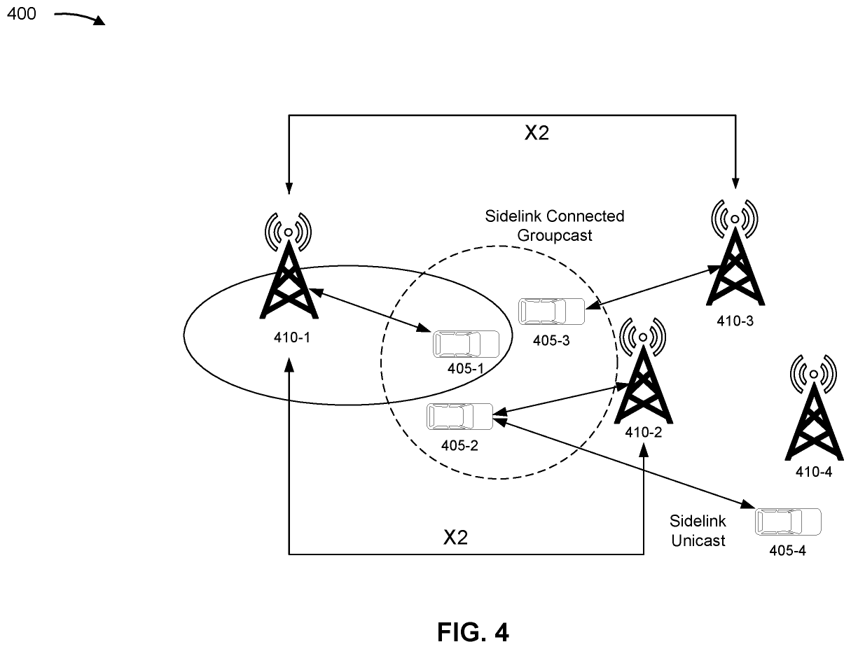

FIG. 4 is a diagram illustrating an example 400 of connected groupcast feedback via V2N2V communication, in accordance with the present disclosure.

As shown in example 400, a first UE 405-1 may be in communication with a first network node 410-1 via a Uu interface. The first UE 405-1 may be in communication with a second UE 405-2 and a third UE 405-3 via a sidelink interface, such as a PC5 interface, or indirect communication via a Uu interface, as discussed below. The second UE 405-2 and the third UE 405-3 may also be in communication with a second network node 410-2 and a third network node 410-3, respectively, via a Uu interface.

In some aspects, the first UE 405-1 may transmit sidelink communications to the second UE 405-2 and the third UE 405-3 via a connected groupcast transmission. For example, the first UE 405-1 may create a sidelink group, which may include the second UE 405-2 and the third UE 405-3, for sidelink broadcasts from the first UE 405-1. The second UE 405-2 and the third UE 405-3 may be included in the sidelink group based, at least in part, on a proximity to the first UE 405-1. The sidelink broadcasts may be transmitted to the second UE 405-2 and the third UE 405-3 via the Uu interface. For example, the first UE 405-1 may transmit the sidelink broadcast to the first network node 410-1. The first network node 410-1 may transmit the sidelink broadcast to the second network node 410-2 and the third network node 410-3. The second network node 410-2 may transmit the sidelink broadcast to the second UE 405-2 and the third network node 410-3 may transmit the sidelink broadcast to the third UE 405-3.

Feedback, such as HARQ feedback, may be transmitted from the second UE 405-2 and the third UE 405-3 to the first UE 405-1. The HARQ feedback may include an ACK indicating that data transmitted from the first UE 405-1 in the sidelink broadcast was received and/or decoded, or a NACK indicating that the data transmitted from the first UE 405-1 in the sidelink broadcast was not received and/or decoded. The second UE 405-2 and the third UE 405-3 may each transmit HARQ feedback in response to each sidelink broadcast.

In some aspects, the second UE 405-2 and/or the third UE 405-3 may transmit the HARQ feedback through a network node, such as network node 410-2 and network node 410-3, respectively. The second network node 410-2 may transmit the HARQ feedback from the second UE 405-2 to the first network node 410-1. The third network node 410-3 may transmit the HARQ feedback from the third UE 405-3 to the first network node 410-1. The first network node 410-1 may transmit the HARQ feedback received from the second UE 405-2 (via the second network node 410-2) and the third UE 405-3 (via the third network node 410-3) to the first UE 405-1 via the Uu interface.

Moreover, in some examples, one of the UEs in the sidelink group may engage in sidelink communications with a UE, via the Uu interface, outside the sidelink group. For example, as shown in example 400 of FIG. 4, the second UE 405-2 may engage in sidelink unicast communications with a fourth UE 405-4, which may be in communication with a fourth network node 410-4 via a Uu interface. In this example, the second network node 405-2 may transmit a sidelink communication to the second network node 410-2. The second network node 410-2 may transmit the sidelink communication to the fourth network node 410-4. The fourth network node 410-4 may transmit the sidelink communication to the fourth UE 405-4. The fourth UE 405-4 may transmit HARQ feedback in response to the sidelink communication. The fourth UE 405-4 may transmit the HARQ feedback to the fourth network node 410-2. The fourth network node 410-4 may transmit the HARQ feedback to the second network node 410-2. The second network node 410-2 may transmit the HARQ feedback to the second UE 405-2.

As indicated above, FIG. 4 is provided as an example. Other examples may differ from what is described with respect to FIG. 4.

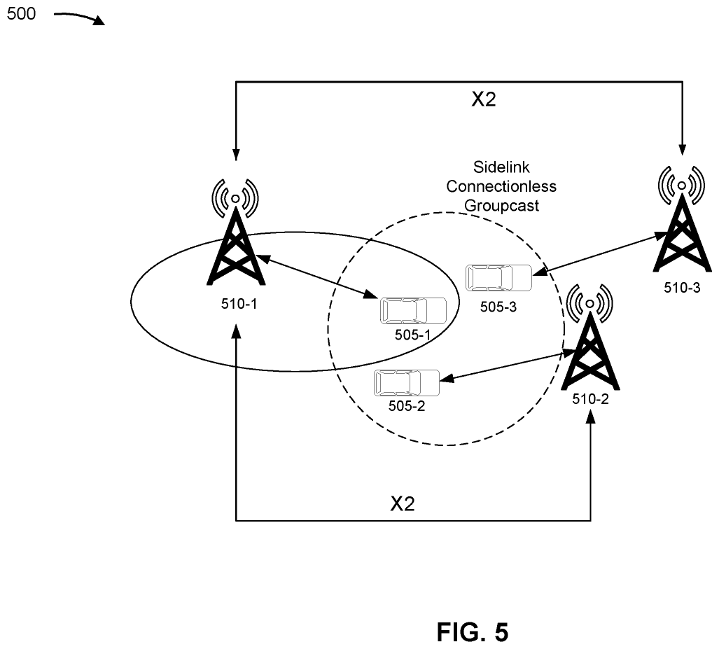

FIG. 5 is a diagram illustrating an example 500 of connectionless groupcast feedback via V2N2V communication, in accordance with the present disclosure.

As shown in example 500, a first UE 505-1 may be in communication with a first network node 510-1 via a Uu interface. The first UE 505-1 may be in direct communication with a second UE 505-2 and a third UE 505-3 via a sidelink interface, such as a PC5 interface, or indirect communication via a Uu interface, as discussed below. The second UE 505-2 and the third UE 505-3 may also be in communication with a second network node 510-2 and a third network node 510-3, respectively, via a Uu interface. In some aspects, one or more of the second UE 505-2 and/or the third UE 505-3 may be operating in a non-connected mode.

In some aspects, the first UE 505-1 may transmit sidelink communications to the second UE 505-2 and the third UE 505-3 via a connectionless groupcast transmission. For example, the first UE 505-1 may broadcast sidelink messages to nearby UEs, which may include the second UE 505-2 and the third UE 505-3. The second UE 505-2 and the third UE 505-3 may receive the sidelink messages due, at least in part, to a proximity of the second UE 505-2 and the third UE 505-3 to the first UE 505-1. The sidelink messages may be transmitted to the second UE 505-2 and the third UE 505-3 via the Uu interface. For example, the first UE 505-1 may transmit the sidelink message to the first network node 510-1. The first network node 510-1 may transmit the sidelink message to the second network node 510-2 and the third network node 510-3. The second network node 510-2 may transmit the sidelink message to the second UE 505-2 and the third network node 510-3 may transmit the sidelink message to the third UE 505-3.

Feedback, such as HARQ feedback, may be transmitted from the second UE 505-2 and the third UE 505-3 to the first UE 505-1. The HARQ feedback may include an ACK indicating that data transmitted from the first UE 505-1 in the sidelink message was received and/or decoded, or a NACK indicating that the data transmitted from the first UE 505-1 in the sidelink message was not received and/or decoded. The second UE 505-2 and the third UE 505-3 may each transmit HARQ feedback in response to each sidelink message.

In some aspects, the second UE 505-2 and/or the third UE 505-3 may transmit the HARQ feedback through a network node, such as network node 510-2 and network node 510-3, respectively. The second network node 510-2 may transmit the HARQ feedback from the second UE 505-2 to the first network node 510-1. The third network node 510-3 may transmit the HARQ feedback from the third UE 505-3 to the first network node 510-1. The first network node 510-1 may transmit the HARQ feedback received from the second UE 505-2 (via the second network node 510-2) and the third UE 505-3 (via the third network node 510-3) to the first UE 505-1 via the Uu interface.

As indicated above, FIG. 5 is provided as an example. Other examples may differ from what is described with respect to FIG. 5.

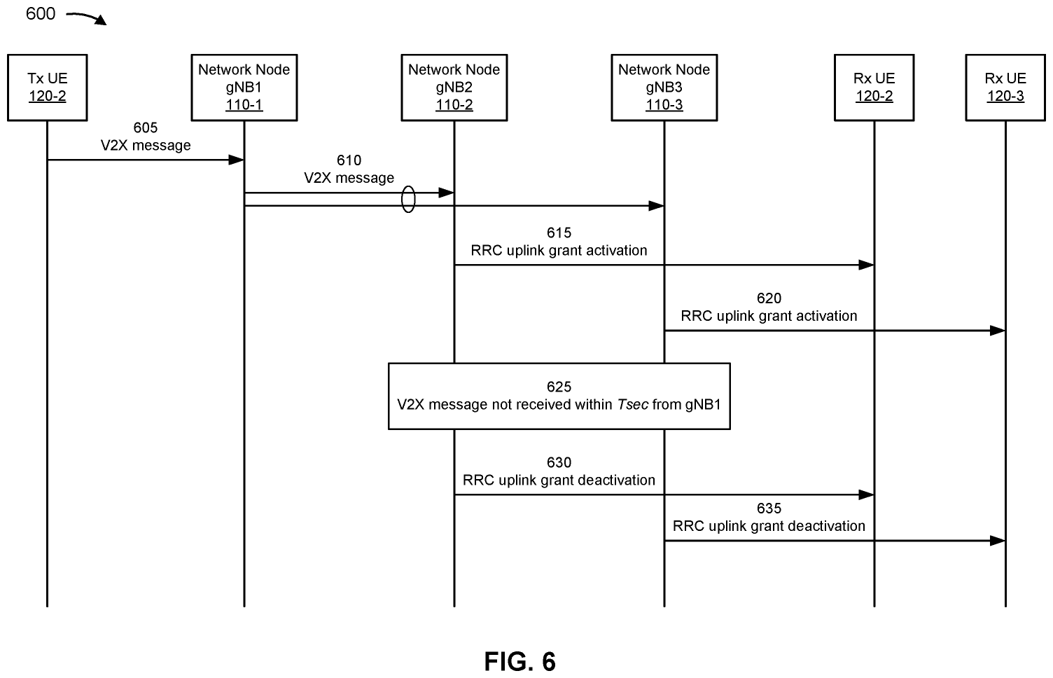

FIG. 6 is a diagram illustrating an example 600 associated with connectionless groupcast sidelink feedback over a Uu interface, in accordance with the present disclosure. As shown in FIG. 6, a first network node 110-1 and a first UE 120-1 may communicate with one another via a Uu interface. The first network node 110-1 may be referred to as a “transmitting network node” and the first UE 120-1 may be referred to as a transmitting UE (Tx UE). The first network node 110-1 may also be in communication with other network nodes, shown as a second network node 110-2 and a third network node 110-3 in FIG. 6, via an X2 interface. The second network node 110-2 and third network node 110-3 may be referred to as receiving network nodes (e.g., the network nodes that receive communications transmitted by the Tx network node), and the second UE 120-2 and the third UE 120-3 may referred to as receiving UEs (Rx UEs) (e.g., the UEs that receive communications transmitted by the Tx UE). The second network node 110-2 may be in communication with a second UE 120-2 via a Uu interface and the third network node 110-3 may be in communication with a third UE 120-3 via a Uu interface.

In a first operation 605, the first UE 120-1 may transmit, and the first network node 110-1 may receive, a V2X message. The V2X message may be a zone- or distance-based V2X message indicating that the V2X message is intended for all UEs (such as the second UE 120-2 and the third UE 120-3) within a specified zone or distance. The V2X message may be transmitted to the first network node 110-1 via a Uu interface.

In a second operation 610, the first network node 110-1 may transmit, and the second network node 110-2 and third network node 110-3 may receive, the V2X message. The first network node 110-1 may determine which network nodes should receive the V2X message. For example, the first network node 110-1 may determine which network nodes serve the UEs within the zone or distance indicated by the V2X message. In the example 600, the second network node 110-2 and the third network node 110-3 may be the intended recipients of the V2X message because the second network node 110-2 and the third network node 110-3 are the serving gNBs of the second UE 120-2 and the third UE 120-3, respectively. The V2X message may be transmitted to the second network node 110-2 and the third network node 110-3 via an X2 interface.

In a third operation 615, the second network node 110-2 may transmit, and the second UE 120-2 may receive, a radio resource control (RRC) uplink grant activation signal. The RRC uplink grant activation signal may activate an uplink grant for the second UE 120-2 to respond to the V2X message with, for example, HARQ feedback or another type of uplink feedback. An indicator, such as a one-bit indicator in downlink control information (DCI), may be provided with the uplink grant activation signal to indicate to the second UE 120-2 that the uplink grant is associated with a V2N2V feedback transmission. The uplink grant activation signal may be transmitted to the second UE 120-2 via a Uu interface.

In a fourth operation 620, the third network node 110-3 may transmit, and the third UE 120-3 may receive, an RRC uplink grant activation signal. The RRC uplink grant activation signal may activate an uplink grant for the third UE 120-3 to respond to the V2X message with, for example, HARQ feedback or another type of uplink feedback. An indicator, such as a one-bit indicator in DCI, may be provided with the uplink grant activation signal to indicate to the second UE 120-2 that the uplink grant is associated with a V2N2V feedback transmission. The uplink grant activation signal may be transmitted to the third UE 120-3 via a Uu interface.

In a fifth operation 625, the second network node 110-2 and the third network node 110-3 may determine that a V2X message has not been received within a period of time T_{sec}. The lack of a V2X message within the period of time T_{sec} may indicate that the first UE 120-1 is no longer sending V2X messages to the second UE 120-2 and the third UE 120-3. As a result of the period of time T_{sec} elapsing without a V2X message from the first network node 110-1, the second network node 110-2 and the third network node 110-3 may proceed to transmit the signals discussed below with respect to operations 630 and 635.

In a sixth operation 630, the second network node 110-2 may transmit, and the second UE 120-2 may receive, an RRC uplink grant deactivation signal. The uplink grant deactivation signal may deactivate the preconfigured grant for the second UE 120-2 to send HARQ feedback or another type of uplink feedback in response to the sidelink V2X message transmitted by the first UE 120-1. The uplink grant deactivation signal may be transmitted to the second UE 120-2 via a Uu interface.

In a seventh operation 635, the third network node 110-3 may transmit, and the third UE 120-3 may receive, an RRC uplink grant deactivation signal. The uplink grant deactivation signal may deactivate the preconfigured grant for the third UE 120-3 to send HARQ feedback or another type of uplink feedback in response to the sidelink V2X message transmitted by the first UE 120-1. The uplink grant deactivation signal may be transmitted to the third UE 120-3 via a Uu interface.

Alternatively, instead of RRC activation and/or deactivation of the uplink grants, the second network node 110-2 and the third network node 110-3 may transmit a physical downlink control channel (PDCCH)-based DCI activation signal based, at least in part, on the receipt of the V2X message from the first network node 110-1. The second network node 110-2 and the third network node 110-3 may transmit a PDCCH-based DCI deactivation signal based, at least in part, on the absence of any V2X messages from the first network node 110-1 for the period of time T_{sec}.

As indicated above, FIG. 6 is provided as an example. Other examples may differ from what is described with respect to FIG. 6.

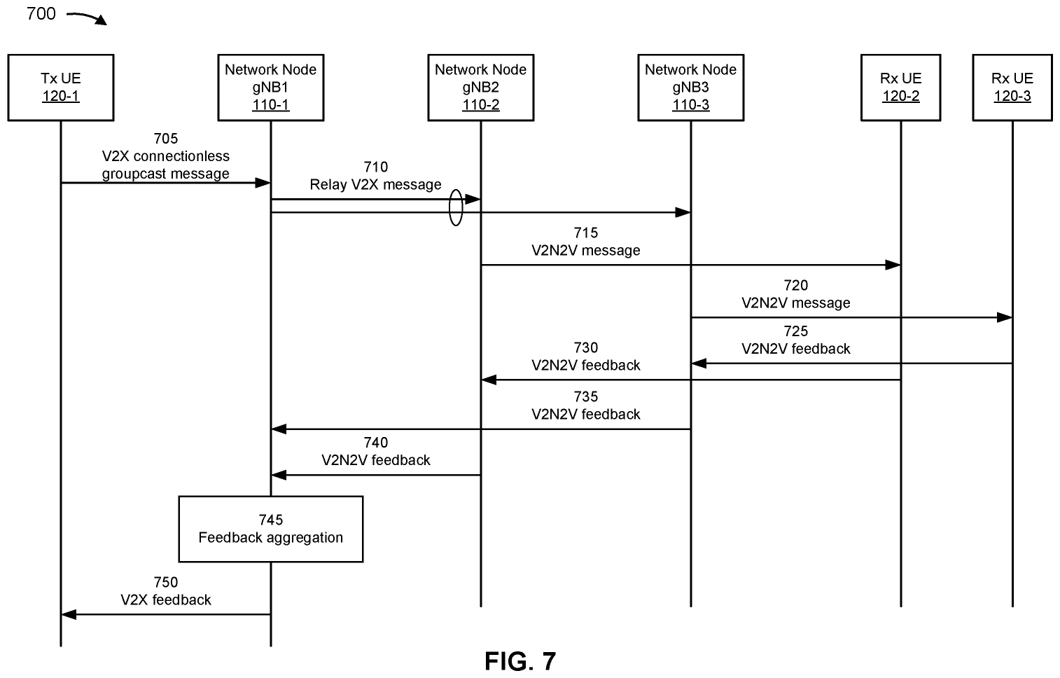

FIG. 7 is a diagram illustrating an example 700 associated with one-to-many connectionless groupcast sidelink feedback over a Uu interface, in accordance with the present disclosure. As shown in FIG. 7, a first network node 110-1 and a first UE 120-1 may communicate with one another via a Uu interface. The first network node 110-1 may be referred to as a “transmitting network node” and the first UE 120-1 may be referred to as a transmitting UE (Tx UE). The first network node 110-1 may also be in communication with other network nodes, shown as a second network node 110-2 and a third network node 110-3 in FIG. 7, via an X2 interface. The second network node 110-2 and third network node 110-3 may be referred to as receiving network nodes, and the second UE 120-2 and the third UE 120-3 may referred to as receiving UEs (Rx UEs). The second network node 110-2 may be in communication with a second UE 120-2 via a Uu interface and the third network node 110-3 may be in communication with a third UE 120-3 via a Uu interface.

In a first operation 705, the first UE 120-1 may transmit, and the first network node 110-1 may receive, a V2X message. The V2X message may be a connectionless groupcast V2X message to all nearby UEs (such as the second UE 120-2 and the third UE 120-3) within broadcast range of the first UE 120-1. The V2X message may be transmitted to the first network node 110-1 via a Uu interface.

In a second operation 710, the first network node 110-1 may transmit, and the second network node 110-2 and third network node 110-3 may receive, the V2X message. The first network node 110-1 may determine which network nodes should receive the V2X message. For example, the first network node 110-1 may determine which network nodes serve the UEs that will receive the connectionless groupcast message based, at least in part, on a broadcast range of the first UE 120-1. In the example 700, the second UE 120-2 and the third UE 120-3 may be within range of the first UE 120-1 to receive the V2X message. As a result, the first network node 110-1 may select the second network node 110-2 and the third network node 110-3 as recipients of the V2X message since the second network node 110-2 and the third network node 110-3 are the serving gNBs of the second UE 120-2 and the third UE 120-3, respectively. The V2x message may be transmitted to the second network node 110-2 and the third network node 110-3 via an X2 interface.

In a third operation 715, the second network node 110-2 may transmit, and the second UE 120-2 may receive, a V2N2V message based, at least in part, on the V2X message that the second network node 110-2 received from the first network node 110-1. The V2N2V message may be transmitted to the second UE 120-2 via a Uu interface.

In a fourth operation 720, the third network node 110-3 may transmit, and the third UE 120-3 may receive, a V2N2V message based, at least in part, on the V2X message that the third network node 110-3 received from the first network node 110-1. The V2N2V message may be transmitted to the third UE 120-3 via a Uu interface.

In a fifth operation 725, the third UE 120-3 may transmit, and the third network node 110-3 may receive, feedback on the V2N2V message. The feedback may include HARQ feedback such as an ACK or NACK indicating whether the V2N2V message was properly received and decoded. The V2N2V feedback may be received at the third network node 110-3 via a Uu interface.

In a sixth operation 730, the second UE 120-2 may transmit, and the second network node 110-2 may receive, feedback on the V2N2V message. The feedback may include HARQ feedback such as an ACK or NACK indicating whether the V2N2V message was properly received and decoded. The V2N2V feedback may be received at the second network node 110-2 via a Uu interface.

In a seventh operation 735, the third network node 110-3 may transmit, and the first network node 110-1 may receive, the V2N2V feedback associated with the third UE 120-3. The third network node 110-3 may transmit the V2N2V feedback associated with the third UE 120-3 to the first network node 110-1 via an X2 interface.

In an eighth operation 740, the second network node 110-2 may transmit, and the first network node 110-1 may receive, the V2N2V feedback associated with the second UE 120-2. The second network node 110-2 may transmit the V2N2V feedback associated with the second UE 120-2 to the first network node 110-1 via an X2 interface.

In a ninth operation 745, the first network node 110-1 may aggregate the V2N2V feedback received from the second network node 110-2, the third network node 110-3, and any other network nodes associated with UEs that may have received the V2X message.

In a tenth operation 750, the first network node 110-1 may transmit, and the first UE 120-1 may receive, V2X feedback. The V2X feedback may include the aggregated V2N2V feedback received by the first network node 110-1. The V2X feedback may be transmitted to the first UE 120-1 via a Uu interface.

As indicated above, FIG. 7 is provided as an example. Other examples may differ from what is described with respect to FIG. 7.

In some aspects, an Rx UE may participate in multiple connected groupcast sessions. When an Rx UE participates in multiple connected groupcasts, the corresponding network nodes may provide uplink grants for providing feedback separately for every connected groupcast in which the Rx UE participates. Alternatively, the uplink grants may be provided to the Rx UE in a multiplexed manner. For example, the groupcast ID for which the Rx UE provides the feedback may depend on a slot number. If the Rx UE is participating in N connected groupcast sessions, the Rx UE may provide feedback for the i^{th} groupcast where i is equal to the slot number mod N. Alternatively, the network node serving the Rx UE may configure the uplink grant implicitly nᵢ slots after the reception of the i^{th} connected groupcast V2N2V message. Alternatively, the Rx UE may transmit feedback along with the group ID associated with the feedback. The network node serving the Rx UE may provide feedback to the appropriate group based, at least in part, on the group ID transmitted with the feedback. In some aspects, the network node serving the Tx UE may explicitly indicate the group ID of the connected groupcast V2X message to the network nodes serving the Rx UEs. The signaling associated with the groupcast ID, slot number, or uplink grants may be transmitted via radio resource control (RRC), DCI, medium access control control element (MAC-CE), and/or a combination thereof, among other examples.

FIG. 8 is a flowchart illustrating an example process 800 performed, for example, by a transmitting UE that supports Uu-based sidelink feedback in accordance with the present disclosure. Example process 800 is an example where the Tx UE (for example, Tx UE 120-1) performs operations associated with Uu-based sidelink feedback.

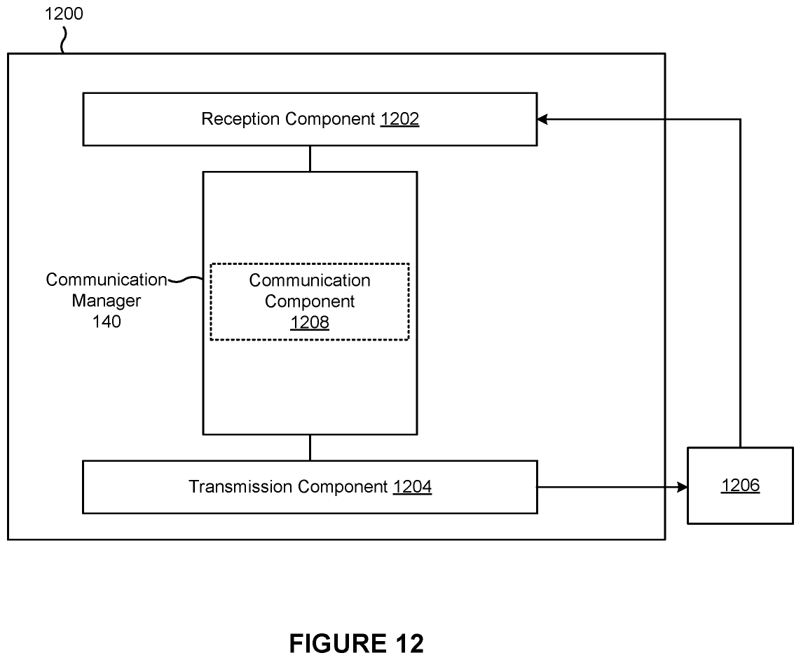

As shown in FIG. 8, in some aspects, process 800 may include receiving a V2N2X configuration for communication with one or more Rx UEs (block 810). For example, the transmitting UE (such as by using communication manager 140 or reception component 1202, depicted in FIG. 12) may receive a V2N2X configuration for communication with one or more Rx UEs, as described above.

As further shown in FIG. 8, in some aspects, process 800 may include transmitting, via a Uu interface, a V2N2X message to a serving network node in accordance with the V2N2X configuration (block 820). For example, the transmitting UE (such as by using communication manager 140 or transmission component 1204, depicted in FIG. 12) may transmit, via a Uu interface, a V2N2X message to a serving network node in accordance with the V2N2X configuration, as described above.

As further shown in FIG. 8, in some aspects, process 800 may include receiving, via the Uu interface, feedback associated with the V2N2X message via the serving network node, the feedback being based, at least in part, on one or more feedback messages output by the one or more Rx UEs (block 830). For example, the transmitting UE (such as by using communication manager 140 or reception component 1202, depicted in FIG. 12) may receive, via the Uu interface, feedback associated with the V2N2X message via the serving network node, the feedback being based, at least in part, on one or more feedback messages output by the one or more Rx UEs, as described above.

Process 800 may include additional aspects, such as any single aspect or any combination of aspects described below or in connection with one or more other processes described elsewhere herein.

In a first additional aspect, the V2N2X message includes a distance-based V2N2X message or a zone-based V2N2X message.

In a second additional aspect, alone or in combination with the first aspect, the one or more feedback messages each include one of an ACK message or a NACK message.

In a third additional aspect, alone or in combination with one or more of the first and second aspects, the feedback includes aggregated feedback associated with the one or more feedback messages output by the one or more Rx UEs.

In a fourth additional aspect, alone or in combination with one or more of the first through third aspects, the V2N2X configuration for communication with the one or more Rx UEs includes a configuration for a broadcast communication, a configuration for a connected groupcast communication, or a configuration for a connectionless groupcast communication.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a UE that supports Uu-based sidelink feedback in accordance with the present disclosure. Example process 900 is an example where the Rx UE (for example, UE 120-2 or 120-3) performs operations associated with Uu-based sidelink feedback.

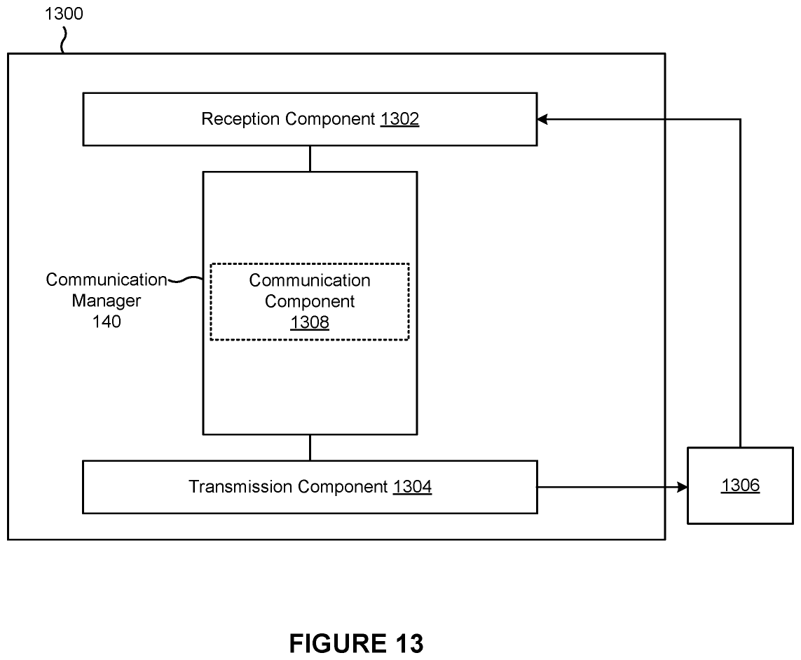

As shown in FIG. 9, in some aspects, process 900 may include receiving, via a Uu interface, one or more V2N2X messages from a serving network node, the one or more V2N2X messages each being associated with a Tx UE (block 910). For example, the UE (such as by using communication manager 140 or reception component 1302, depicted in FIG. 13) may receive, via a Uu interface, one or more V2N2X messages from a serving network node, the one or more V2N2X messages each being associated with a Tx UE, as described above.

As further shown in FIG. 9, in some aspects, process 900 may include receiving one or more uplink feedback configurations from the serving network node (block 920). For example, the UE (such as by using communication manager 140 or reception component 1302, depicted in FIG. 13) may receive one or more uplink feedback configurations from the serving network node, as described above.

As further shown in FIG. 9, in some aspects, process 900 may include transmitting, via the Uu interface, one or more feedback messages, each associated with at least one of the one or more V2N2X messages, to the serving network node in accordance with the one or more uplink feedback configurations (block 930). For example, the UE (such as by using communication manager 140 or transmission component 1304, depicted in FIG. 13) may transmit, via the Uu interface, one or more feedback messages, each associated with at least one of the one or more V2N2X messages, to the serving network node in accordance with the one or more uplink feedback configurations, as described above.

Process 900 may include additional aspects, such as any single aspect or any combination of aspects described below or in connection with one or more other processes described elsewhere herein.

In a first additional aspect, each of the one or more uplink feedback configurations is associated with a different connected groupcast communication.

In a second additional aspect, alone or in combination with the first aspect, receiving the one or more uplink feedback configurations includes receiving the one or more uplink feedback configurations as one or more separate or multiplexed uplink feedback configurations.

In a third additional aspect, alone or in combination with one or more of the first and second aspects, the one or more V2N2X messages include one more distance-based V2N2X messages or one or more zone-based V2N2X messages.

In a fourth additional aspect, alone or in combination with one or more of the first through third aspects, the one or more feedback messages each include one of an ACK or a NACK.

In a fifth additional aspect, alone or in combination with one or more of the first through fourth aspects, the one or more uplink feedback configurations are received via radio resource control signaling, downlink control information signaling, or MAC-CE signaling.

In a sixth additional aspect, alone or in combination with one or more of the first through fifth aspects, process 900 includes transmitting the V2N2X message to a different Rx UE via a sidelink interface.

In a seventh additional aspect, alone or in combination with one or more of the first through sixth aspects, process 900 includes receiving a sidelink feedback message from the different Rx UE and transmitting the sidelink feedback message from the different Rx UE to the serving network node via the Uu interface.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, by a transmitting network node that supports Uu-based sidelink feedback in accordance with the present disclosure. Example process 1000 is an example where the transmitting network node (for example, transmitting network node 110) performs operations associated with Uu-based sidelink feedback.

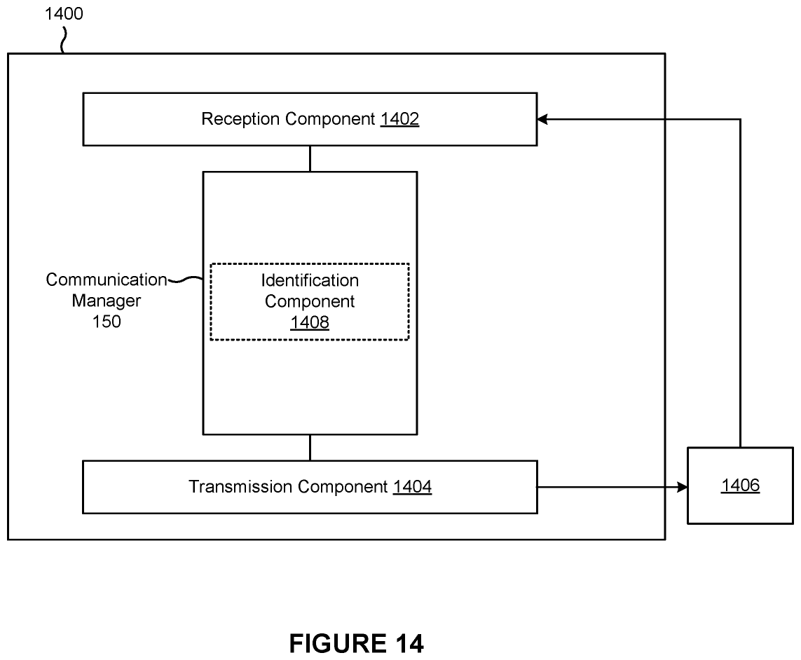

As shown in FIG. 10, in some aspects, process 1000 may include identifying one or more receiving network nodes, each associated with one or more Rx UEs (block 1010). For example, the transmitting network node (such as by using communication manager 150 or identification component 1408, depicted in FIG. 14) may identify one or more receiving network nodes, each associated with one or more Rx UEs, as described above.

As further shown in FIG. 10, in some aspects, process 1000 may include receiving, via a Uu interface, a V2N2X message transmitted by a Tx UE (block 1020). For example, the transmitting network node (such as by using communication manager 150 or reception component 1402, depicted in FIG. 14) may receive, via a Uu interface, a V2N2X message transmitted by a Tx UE, as described above.

As further shown in FIG. 10, in some aspects, process 1000 may include transmitting the V2N2X message to the one or more receiving network nodes via an X2 interface (block 1030). For example, the transmitting network node (such as by using communication manager 150 or transmission component 1404, depicted in FIG. 14) may transmit the V2N2X message to the one or more receiving network nodes via an X2 interface, as described above.

As further shown in FIG. 10, in some aspects, process 1000 may include receiving one or more feedback messages from the one or more Rx UEs (block 1040). For example, the transmitting network node (such as by using communication manager 150 or reception component 1402, depicted in FIG. 14) may receive one or more feedback messages from the one or more Rx UEs, as described above.

As further shown in FIG. 10, in some aspects, process 1000 may include transmitting feedback to the Tx UE via the Uu interface, the feedback being based, at least in part, on the one or more feedback messages received from the one or more Rx UEs (block 1050). For example, the transmitting network node (such as by using communication manager 150 or transmission component 1404, depicted in FIG. 14) may transmit feedback to the Tx UE via the Uu interface, the feedback being based, at least in part, on the one or more feedback messages received from the one or more Rx UEs, as described above.

Process 1000 may include additional aspects, such as any single aspect or any combination of aspects described below or in connection with one or more other processes described elsewhere herein.

In a first additional aspect, transmitting the V2N2X message to the one or more receiving network nodes includes transmitting the V2N2X message with a group identifier.

In a second additional aspect, alone or in combination with the first aspect, transmitting the V2N2X message to the one or more receiving network nodes includes transmitting the V2N2X message with a message type indication.

In a third additional aspect, alone or in combination with one or more of the first and second aspects, the message type indication identifies the V2N2X message as a broadcast message, a connected groupcast message, or a connectionless groupcast message.

In a fourth additional aspect, alone or in combination with one or more of the first through third aspects, the feedback includes aggregated feedback associated with the one or more feedback messages output by the one or more receiving network nodes.

In a fifth additional aspect, alone or in combination with one or more of the first through fourth aspects, the feedback is based, at least in part, on an implicit acknowledgement or an explicit acknowledgement, from the one or more receiving network nodes, that the V2N2X message was received by at least one of the one or more Rx UEs.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a receiving network node that supports Uu-based sidelink feedback in accordance with the present disclosure. Example process 1100 is an example where the receiving network node (for example, receiving network node 110) performs operations associated with Uu-based sidelink feedback.

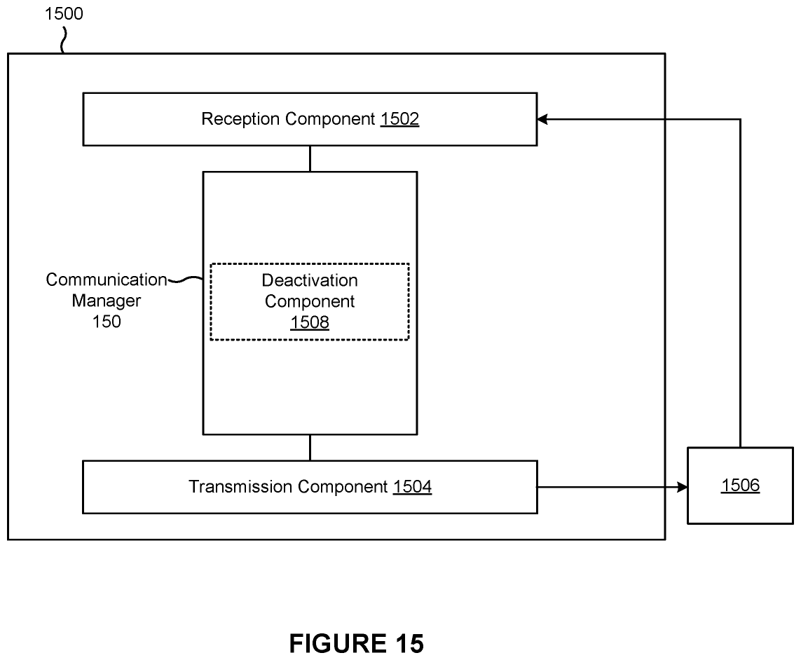

As shown in FIG. 11, in some aspects, process 1100 may include receiving, via an X2 interface, a V2N2X message from a transmitting network node (block 1110). For example, the receiving network node (such as by using communication manager 150 or reception component 1502, depicted in FIG. 15) may receive, via an X2 interface, a V2N2X message from a transmitting network node, as described above.

As further shown in FIG. 11, in some aspects, process 1100 may include transmitting, via a Uu interface, one or more uplink feedback configurations to one or more Rx UEs (block 1120). For example, the receiving network node (such as by using communication manager 150 or transmission component 1504, depicted in FIG. 15) may transmit, via a Uu interface, one or more uplink feedback configurations to one or more Rx UEs, as described above.

As further shown in FIG. 11, in some aspects, process 1100 may include receiving, via the Uu interface, one or more feedback messages, each associated with one of the one or more Rx UEs (block 1130). For example, the receiving network node (such as by using communication manager 150 or reception component 1502, depicted in FIG. 15) may receive, via the Uu interface, one or more feedback messages, each associated with one of the one or more Rx UEs, as described above.

As further shown in FIG. 11, in some aspects, process 1100 may include transmitting each of the one or more feedback messages to the transmitting network node via the X2 interface (block 1140). For example, the receiving network node (such as by using communication manager 150 or transmission component 1504, depicted in FIG. 15) may transmit each of the one or more feedback messages to the transmitting network node via the X2 interface, as described above.

Process 1100 may include additional aspects, such as any single aspect or any combination of aspects described below or in connection with one or more other processes described elsewhere herein.

In a first additional aspect, transmitting the one or more uplink feedback configurations to the one or more Rx UEs includes transmitting the one or more uplink feedback configurations to the one or more Rx UEs via downlink control information signaling.

In a second additional aspect, alone or in combination with the first aspect, at least one of the one or more uplink feedback configurations includes a semi-static uplink grant.

In a third additional aspect, alone or in combination with one or more of the first and second aspects, process 1100 includes deactivating the semi-static uplink grant after a predetermined amount of time since the V2N2X message was received from the transmitting network node.

In a fourth additional aspect, alone or in combination with one or more of the first through third aspects, process 1100 includes deactivating the semi-static uplink grant after a predetermined amount of time since a last communication associated with the V2N2X message was received from the transmitting network node.

In a fifth additional aspect, alone or in combination with one or more of the first through fourth aspects, receiving the V2N2X message includes receiving the V2N2X message with a group identifier, and transmitting the one or more uplink feedback configurations includes transmitting the one or more uplink feedback configurations with the group identifier.

In a sixth additional aspect, alone or in combination with one or more of the first through fifth aspects, receiving the V2N2X message includes receiving the V2N2X message with a message type indication.

In a seventh additional aspect, alone or in combination with one or more of the first through sixth aspects, the message type indication identifies the V2N2X message as a broadcast message, a connected groupcast message, or a connectionless groupcast message.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports Uu-based sidelink feedback in accordance with the present disclosure. The apparatus 1200 may be a Tx UE, or a Tx UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 4-7. Additionally or alternatively, the apparatus 1200 may be configured to and/or operable to perform one or more processes described herein, such as process 800 of FIG. 8. In some aspects, the apparatus 1200 may include one or more components of the Tx UE described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the Tx UE described above in connection with FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the Tx UE described above in connection with FIG. 2. In some aspects, the transmission component 1204 may be co-located with the reception component 1202 in a transceiver.

The communication manager 140 may receive or may cause the reception component 1202 to receive a V2N2X configuration for communication with one or more Rx UEs. The communication manager 140 may transmit or may cause the transmission component 1204 to transmit, via a Uu interface, a V2N2X message to a serving network node in accordance with the V2N2X configuration. The communication manager 140 may receive or may cause the reception component 1202 to receive, via the Uu interface, feedback associated with the V2N2X message via the serving network node, the feedback being based, at least in part, on one or more feedback messages output by the one or more Rx UEs. In some aspects, the communication manager 140 may perform one or more operations described elsewhere herein as being performed by one or more components of the communication manager 140.

The communication manager 140 may include a controller/processor and/or a memory of the Tx UE described above in connection with FIG. 2. In some aspects, the communication manager 140 includes a set of components, such as a communication component 1208. Alternatively, the set of components may be separate and distinct from the communication manager 140. In some aspects, one or more components of the set of components may include or may be implemented within a controller/processor and/or a memory of the Tx UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive a V2N2X configuration for communication with one or more Rx UEs. The transmission component 1204 may transmit, via a Uu interface, a V2N2X message to a serving network node in accordance with the V2N2X configuration. The reception component 1202 may receive, via the Uu interface, feedback associated with the V2N2X message via the serving network node, the feedback being based, at least in part, on one or more feedback messages output by the one or more Rx UEs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports Uu-based sidelink feedback in accordance with the present disclosure. The apparatus 1300 may be an Rx UE, or an Rx UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIGS. 4-7. Additionally or alternatively, the apparatus 1300 may be configured to and/or operable to perform one or more processes described herein, such as process 900 of FIG. 9. In some aspects, the apparatus 1300 may include one or more components of the Rx UE described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, and/or a memory of the Rx UE described above in connection with FIG. 2.

The transmission component 1304 may transmit communications, such as reference signals, control information, and/or data communications, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, and/or a memory of the Rx UE described above in connection with FIG. 2. In some aspects, the transmission component 1304 may be co-located with the reception component 1302 in a transceiver.

The communication manager 140 may receive or may cause the reception component 1302 to receive, via a Uu interface, one or more V2N2X messages from a serving network node, the one or more V2N2X messages each being associated with a Tx UE. The communication manager 140 may receive or may cause the reception component 1302 to receive one or more uplink feedback configurations from the serving network node. The communication manager 140 may transmit or may cause the transmission component 1304 to transmit, via the Uu interface, one or more feedback messages, each associated with at least one of the one or more V2N2X messages, to the serving network node in accordance with the one or more uplink feedback configurations. In some aspects, the communication manager 140 may perform one or more operations described elsewhere herein as being performed by one or more components of the communication manager 140.

The communication manager 140 may include a controller/processor and/or a memory of the Rx UE described above in connection with FIG. 2. In some aspects, the communication manager 140 includes a set of components, such as a communication component 1308. Alternatively, the set of components may be separate and distinct from the communication manager 140. In some aspects, one or more components of the set of components may include or may be implemented within a controller/processor and/or a memory of the Rx UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive, via a Uu interface, one or more V2N2X messages from a serving network node, the one or more V2N2X messages each being associated with a Tx UE. The reception component 1302 may receive one or more uplink feedback configurations from the serving network node. The transmission component 1304 may transmit, via the Uu interface, one or more feedback messages, each associated with at least one of the one or more V2N2X messages, to the serving network node in accordance with the one or more uplink feedback configurations.

The transmission component 1304 may transmit the V2N2X message to a different Rx UE via a sidelink interface.

The reception component 1302 may receive a sidelink feedback message from the different Rx UE and transmit the sidelink feedback message from the different Rx UE to the serving network node via the Uu interface.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports Uu-based sidelink feedback in accordance with the present disclosure. The apparatus 1400 may be a Tx network node, or a Tx network node may include the apparatus 1400. In some aspects, the apparatus 1400 includes a reception component 1402, a transmission component 1404, and a communication manager 150, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 4-7. Additionally or alternatively, the apparatus 1400 may be configured to and/or operable to perform one or more processes described herein, such as process 1000 of FIG. 10. In some aspects, the apparatus 1400 may include one or more components of the Tx network node described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 150. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, and/or a memory of the Tx network node described above in connection with FIG. 2.

The transmission component 1404 may transmit communications, such as reference signals, control information, and/or data communications, to the apparatus 1406. In some aspects, the communication manager 150 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, and/or a memory of the Tx network node described above in connection with FIG. 2. In some aspects, the transmission component 1404 may be co-located with the reception component 1402 in a transceiver.

The communication manager 150 may identify one or more receiving network nodes, each associated with one or more Rx UEs. The communication manager 150 may receive or may cause the reception component 1402 to receive, via a Uu interface, a V2N2X message transmitted by a Tx UE. The communication manager 150 may transmit or may cause the transmission component 1404 to transmit the V2N2X message to the one or more receiving network nodes via an X2 interface. The communication manager 150 may receive or may cause the reception component 1402 to receive one or more feedback messages from the one or more Rx UEs. The communication manager 150 may transmit or may cause the transmission component 1404 to transmit feedback to the Tx UE via the Uu interface, the feedback being based, at least in part, on the one or more feedback messages received from the one or more Rx UEs. In some aspects, the communication manager 150 may perform one or more operations described elsewhere herein as being performed by one or more components of the communication manager 150.

The communication manager 150 may include a controller/processor, a memory, a scheduler, and/or a communication unit of the Tx network node described above in connection with FIG. 2. In some aspects, the communication manager 150 includes a set of components, such as an identification component 1408. Alternatively, the set of components may be separate and distinct from the communication manager 150. In some aspects, one or more components of the set of components may include or may be implemented within a controller/processor, a memory, a scheduler, and/or a communication unit of the Tx network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The identification component 1408 may identify one or more receiving network nodes, each associated with one or more Rx UEs. The reception component 1402 may receive, via a Uu interface, a V2N2X message transmitted by a Tx UE. The transmission component 1404 may transmit the V2N2X message to the one or more receiving network nodes via an X2 interface. The reception component 1402 may receive one or more feedback messages from the one or more Rx UEs. The transmission component 1404 may transmit feedback to the Tx UE via the Uu interface, the feedback being based, at least in part, on the one or more feedback messages received from the one or more Rx UEs.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

FIG. 15 is a diagram of an example apparatus 1500 for wireless communication that supports Uu-based sidelink feedback in accordance with the present disclosure. The apparatus 1500 may be a Rx network node, or a Rx network node may include the apparatus 1500. In some aspects, the apparatus 1500 includes a reception component 1502, a transmission component 1504, and a communication manager 150, which may be in communication with one another (for example, via one or more buses). As shown, the apparatus 1500 may communicate with another apparatus 1506 (such as a UE, a network node, or another wireless communication device) using the reception component 1502 and the transmission component 1504.

In some aspects, the apparatus 1500 may be configured to and/or operable to perform one or more operations described herein in connection with FIGS. 4-7. Additionally or alternatively, the apparatus 1500 may be configured to and/or operable to perform one or more processes described herein, such as process 1100 of FIG. 11. In some aspects, the apparatus 1500 may include one or more components of the Rx network node described above in connection with FIG. 2.

The reception component 1502 may receive communications, such as reference signals, control information, and/or data communications, from the apparatus 1506. The reception component 1502 may provide received communications to one or more other components of the apparatus 1500, such as the communication manager 150. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1502 may include one or more antennas, a modem, a demodulator, a MIMO detector, a receive processor, a controller/processor, and/or a memory of the Rx network node described above in connection with FIG. 2.

The transmission component 1504 may transmit communications, such as reference signals, control information, and/or data communications, to the apparatus 1506. In some aspects, the communication manager 150 may generate communications and may transmit the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, and/or a memory of the Rx network node described above in connection with FIG. 2. In some aspects, the transmission component 1504 may be co-located with the reception component 1502 in a transceiver.

The communication manager 150 may receive or may cause the reception component 1502 to receive, via an X2 interface, a V2N2X message from a transmitting network node. The communication manager 150 may transmit or may cause the transmission component 1504 to transmit, via a Uu interface, one or more uplink feedback configurations to one or more Rx UEs. The communication manager 150 may receive or may cause the reception component 1502 to receive, via the Uu interface, one or more feedback messages, each associated with one of the one or more Rx UEs. The communication manager 150 may transmit or may cause the transmission component 1504 to transmit each of the one or more feedback messages to the transmitting network node via the X2 interface. In some aspects, the communication manager 150 may perform one or more operations described elsewhere herein as being performed by one or more components of the communication manager 150.

The communication manager 150 may include a controller/processor, a memory, a scheduler, and/or a communication unit of the Rx network node described above in connection with FIG. 2. In some aspects, the communication manager 150 includes a set of components, such as a deactivation component 1508. Alternatively, the set of components may be separate and distinct from the communication manager 150. In some aspects, one or more components of the set of components may include or may be implemented within a controller/processor, a memory, a scheduler, and/or a communication unit of the Rx network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive, via an X2 interface, a V2N2X message from a transmitting network node. The transmission component 1504 may transmit, via a Uu interface, one or more uplink feedback configurations to one or more Rx UEs. The reception component 1502 may receive, via the Uu interface, one or more feedback messages, each associated with one of the one or more Rx UEs. The transmission component 1504 may transmit each of the one or more feedback messages to the transmitting network node via the X2 interface.

The deactivation component 1508 may deactivate the semi-static uplink grant after a predetermined amount of time since the V2N2X message was received from the transmitting network node.

The deactivation component 1508 may deactivate the semi-static uplink grant after a predetermined amount of time since a last communication associated with the V2N2X message was received from the transmitting network node.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a Tx UE, comprising: receiving a V2N2X configuration for communication with one or more Rx UEs; transmitting, via a Uu interface, a V2N2X message to a serving network node in accordance with the V2N2X configuration; and receiving, via the Uu interface, feedback associated with the V2N2X message via the serving network node, the feedback being based, at least in part, on one or more feedback messages output by the one or more Rx UEs.

Aspect 2: The method of Aspect 1, wherein the V2N2X message includes a distance-based V2N2X message or a zone-based V2N2X message.

Aspect 3: The method of any of Aspects 1-2, wherein the one or more feedback messages each include one of an ACK message or a NACK message.

Aspect 4: The method of any of Aspects 1-3, wherein the feedback includes aggregated feedback associated with the one or more feedback messages output by the one or more Rx UEs.

Aspect 5: The method of any of Aspects 1-4, wherein the V2N2X configuration for communication with the one or more Rx UEs includes a configuration for a broadcast communication, a configuration for a connected groupcast communication, or a configuration for a connectionless groupcast communication.

Aspect 6: A method of wireless communication performed by an Rx UE, comprising: receiving, via a Uu interface, one or more V2N2X messages from a serving network node, the one or more V2N2X messages each being associated with a Tx UE; receiving one or more uplink feedback configurations from the serving network node; and transmitting, via the Uu interface, one or more feedback messages, each associated with at least one of the one or more V2N2X messages, to the serving network node in accordance with the one or more uplink feedback configurations.

Aspect 7: The method of Aspect 6, wherein each of the one or more uplink feedback configurations is associated with a different connected groupcast communication.

Aspect 8: The method of any of Aspects 6-7, wherein transmitting the one or more feedback messages includes transmitting the one or more feedback messages associated with an i^{th} groupcast of N number of connected groupcasts, wherein i is equal to a slot number mod N.

Aspect 9: The method of any of Aspects 6-8, wherein transmitting the one or more feedback messages includes transmitting the one or more feedback messages with a group identifier.

Aspect 10: The method of any of Aspects 6-9, wherein receiving the one or more uplink feedback configurations includes receiving the one or more uplink feedback configurations as one or more separate or multiplexed uplink feedback configurations.

Aspect 11: The method of any of Aspects 6-10, wherein the one or more V2N2X messages include one more distance-based V2N2X messages or one or more zone-based V2N2X messages.

Aspect 12: The method of any of Aspects 6-11, wherein the one or more feedback messages each include one of an ACK or a NACK.

Aspect 13: The method of any of Aspects 6-12, wherein the one or more uplink feedback configurations are received via radio resource control signaling, downlink control information signaling, or MAC-CE signaling.

Aspect 14: The method of any of Aspects 6-13, further comprising transmitting the V2N2X message to a different Rx UE via a sidelink interface.

Aspect 15: The method of Aspect 14, further comprising receiving a sidelink feedback message from the different Rx UE and transmitting the sidelink feedback message from the different Rx UE to the serving network node via the Uu interface.

Aspect 16: A method of wireless communication performed by a transmitting network node, comprising: identifying one or more receiving network nodes, each associated with one or more Rx UEs; receiving, via a Uu interface, a V2N2X message transmitted by a Tx UE; transmitting the V2N2X message to the one or more receiving network nodes via an X2 interface; receiving one or more feedback messages from the one or more Rx UEs; and transmitting feedback to the Tx UE via the Uu interface, the feedback being based, at least in part, on the one or more feedback messages received from the one or more Rx UEs.

Aspect 17: The method of Aspect 16, wherein transmitting the V2N2X message to the one or more receiving network nodes includes transmitting the V2N2X message with a group identifier.

Aspect 18: The method of any of Aspects 14-17, wherein transmitting the V2N2X message to the one or more receiving network nodes includes transmitting the V2N2X message with a message type indication.

Aspect 19: The method of Aspect 18, wherein the message type indication identifies the V2N2X message as a broadcast message, a connected groupcast message, or a connectionless groupcast message.

Aspect 20: The method of any of Aspects 14-19, wherein the feedback includes aggregated feedback associated with the one or more feedback messages output by the one or more receiving network nodes.

Aspect 21: The method of any of Aspects 14-20, wherein the feedback is based, at least in part, on an implicit acknowledgement or an explicit acknowledgement, from the one or more receiving network nodes, that the V2N2X message was received by at least one of the one or more Rx UEs.

Aspect 22: A method of wireless communication performed by a receiving network node, comprising: receiving, via an X2 interface, a V2N2X message from a transmitting network node; transmitting, via a Uu interface, one or more uplink feedback configurations to one or more Rx UEs; receiving, via the Uu interface, one or more feedback messages, each associated with one of the one or more Rx UEs; and transmitting each of the one or more feedback messages to the transmitting network node via the X2 interface.

Aspect 23: The method of Aspect 22, wherein transmitting the one or more uplink feedback configurations to the one or more Rx UEs includes transmitting the one or more uplink feedback configurations to the one or more Rx UEs via downlink control information signaling.

Aspect 24: The method of any of Aspects 20-23, wherein at least one of the one or more uplink feedback configurations includes a semi-static uplink grant.

Aspect 25: The method of Aspect 24, further comprising deactivating the semi-static uplink grant after a predetermined amount of time since the V2N2X message was received from the transmitting network node.

Aspect 26: The method of Aspect 25, further comprising deactivating the semi-static uplink grant after a predetermined amount of time since a last communication associated with the V2N2X message was received from the transmitting network node.

Aspect 27: The method of Aspect 22, wherein at least one of the one or more uplink feedback configurations includes a configuration for an uplink grant to occur a number of slots after reception of a connected groupcast message.

Aspect 28: The method of any of Aspects 20-27, wherein receiving the V2N2X message includes receiving the V2N2X message with a group identifier, and wherein transmitting the one or more uplink feedback configurations includes transmitting the one or more uplink feedback configurations with the group identifier.

Aspect 29: The method of any of Aspects 20-28, wherein receiving the V2N2X message includes receiving the V2N2X message with a message type indication.

Aspect 30: The method of Aspect 29, wherein the message type indication identifies the V2N2X message as a broadcast message, a connected groupcast message, or a connectionless groupcast message.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a transmitting user equipment (Tx UE), comprising:
one or more memories storing processor-executable code; and
one or more processors coupled to the one or more memories, at least one of the one or more processors configured to cause the Tx UE to:
receive a vehicle-to-network-to-everything (V2N2X) configuration for communication with one or more receiving UEs (Rx UEs);
transmit, via a Uu interface, a V2N2X message to a serving network node in accordance with the V2N2X configuration; and
receive, via the Uu interface, feedback associated with the V2N2X message via the serving network node, the feedback being associated with one or more feedback messages output by the one or more Rx UEs.

2. The apparatus of claim 1, wherein the V2N2X message includes a distance-based V2N2X message or a zone-based V2N2X message.

3. The apparatus of claim 1, wherein the one or more feedback messages each include one of an acknowledgement (ACK) message or a negative acknowledgement (NACK) message.

4. The apparatus of claim 1, wherein the feedback includes aggregated feedback associated with the one or more feedback messages output by the one or more Rx UEs.

5. The apparatus of claim 1, wherein the V2N2X configuration for communication with the one or more Rx UEs includes a configuration for a broadcast communication, a configuration for a connected groupcast communication, or a configuration for a connectionless groupcast communication.

6. An apparatus for wireless communication at a receiving user equipment (Rx UE), comprising:
one or more memories storing processor-executable code; and
one or more processors coupled to the one or more memories, at least one of the one or more processors configured to cause the Rx UE to:
receive, via a Uu interface, one or more vehicle-to-network-to-everything (V2N2X) messages from a serving network node, the one or more V2N2X messages each being associated with a transmitting UE (Tx UE);
receive one or more uplink feedback configurations from the serving network node; and
transmit, via the Uu interface, one or more feedback messages, each associated with at least one of the one or more V2N2X messages, to the serving network node in accordance with the one or more uplink feedback configurations.

7. The apparatus of claim 6, wherein each of the one or more uplink feedback configurations is associated with a different connected groupcast communication.

8. The apparatus of claim 6, wherein transmitting the one or more feedback messages includes transmitting the one or more feedback messages associated with an i^{th} groupcast of N number of connected groupcasts, wherein i is equal to a slot number mod N.

9. The apparatus of claim 6, wherein transmitting the one or more feedback messages includes transmitting the one or more feedback messages with a group identifier.

10. The apparatus of claim 6, wherein at least one processor of the one or more processors, to receive the one or more uplink feedback configurations, are configured to cause the Rx UE to receive the one or more uplink feedback configurations as one or more separate or multiplexed uplink feedback configurations.

11. The apparatus of claim 6, wherein the one or more V2N2X messages include one more distance-based V2N2X messages or one or more zone-based V2N2X messages.

12. The apparatus of claim 6, wherein the one or more feedback messages each include one of an acknowledgement (ACK) or a negative acknowledgement (NACK).

13. The apparatus of claim 6, wherein the one or more uplink feedback configurations are received via radio resource control signaling, downlink control information signaling, or medium access control (MAC) control element (MAC-CE) signaling.

14. The apparatus of claim 6, wherein at least one processor of the one or more processors is further configured to cause the Rx UE to transmit the V2N2X message to a different Rx UE via a sidelink interface.

15. The apparatus of claim 14, wherein at least one processor of the one or more processors is further configured to cause the Rx UE to receive a sidelink feedback message from the different Rx UE and transmit the sidelink feedback message from the different Rx UE to the serving network node via the Uu interface.

16. An apparatus for wireless communication at a transmitting network node, comprising:
one or more memories storing processor-executable code; and
one or more processors coupled to the one or more memories, at least one of the one or more processors configured to cause the transmitting network node to:
identify one or more receiving network nodes, each associated with one or more receiving user equipments (UEs) (Rx UEs);
receive, via a Uu interface, a vehicle-to-network-to-everything (V2N2X) message transmitted by a transmitting UE (Tx UE);
transmit the V2N2X message to the one or more receiving network nodes via an X2 interface;
receive one or more feedback messages from the one or more Rx UEs; and
transmit feedback to the Tx UE via the Uu interface, the feedback being associated with the one or more feedback messages received from the one or more Rx UEs.

17. The apparatus of claim 16, wherein at least one processor of the one or more processors, to transmit the V2N2X message to the one or more receiving network nodes, are configured to cause the transmitting network node to transmit the V2N2X message with a group identifier.

18. The apparatus of claim 16, wherein at least one processor of the one or more processors, to transmit the V2N2X message to the one or more receiving network nodes, are configured to cause the transmitting network node to transmit the V2N2X message with a message type indication.

19. The apparatus of claim 18, wherein the message type indication identifies the V2N2X message as a broadcast message, a connected groupcast message, or a connectionless groupcast message.

20. The apparatus of claim 16, wherein the feedback includes aggregated feedback associated with the one or more feedback messages output by the one or more receiving network nodes.

21. The apparatus of claim 16, wherein the feedback is associated with an implicit acknowledgement or an explicit acknowledgement, from the one or more receiving network nodes, that the V2N2X message was received by at least one of the one or more Rx UEs.

22. An apparatus for wireless communication at a receiving network node, comprising:
one or more memories storing processor-executable code; and
one or more processors coupled to the one or more memories, at least one of the one or more processors configured to cause the receiving network node to:
receive, via an X2 interface, a vehicle-to-network-to-everything (V2N2X) message from a transmitting network node;
transmit, via a Uu interface, one or more uplink feedback configurations to one or more receiving user equipments (Rx UEs);
receive, via the Uu interface, one or more feedback messages, each associated with one of the one or more Rx UEs; and
transmit each of the one or more feedback messages to the transmitting network node via the X2 interface.

23. The apparatus of claim 22, wherein at least one processor of the one or more processors, to transmit the one or more uplink feedback configurations to the one or more Rx UEs, are configured to cause the receiving network node to transmit the one or more uplink feedback configurations to the one or more Rx UEs via downlink control information signaling.

24. The apparatus of claim 22, wherein at least one of the one or more uplink feedback configurations includes a semi-static uplink grant.

25. The apparatus of claim 24, wherein at least one processor of the one or more processors is further configured to cause the receiving network node to deactivate the semi-static uplink grant after a predetermined amount of time since the V2N2X message was received from the transmitting network node.

26. The apparatus of claim 24, wherein at least one processor of the one or more processors is further configured to cause the receiving network node to deactivate the semi-static uplink grant after a predetermined amount of time since a last communication associated with the V2N2X message was received from the transmitting network node.

27. The apparatus of claim 22, wherein at least one of the one or more uplink feedback configurations includes a configuration for an uplink grant to occur a number of slots after reception of a connected groupcast message.

28. The apparatus of claim 22, wherein receiving the V2N2X message includes receiving the V2N2X message with a group identifier, and wherein transmitting the one or more uplink feedback configurations includes transmitting the one or more uplink feedback configurations with the group identifier.

29. The apparatus of claim 22, wherein at least one processor of the one or more processors, to receive the V2N2X message, are configured to cause the receiving network node to receive the V2N2X message with a message type indication.

30. The apparatus of claim 29, wherein the message type indication identifies the V2N2X message as a broadcast message, a connected groupcast message, or a connectionless groupcast message.
